(19) United States
(12) Patent Application Publication
(10) Pub. No.: US 2025/0346722 A1
(43) Pub. Date: Nov. 13, 2025

(54) SILICONE PURIFICATION AND DEODORIZATION PROCESS FROM WASHING COSMETIC MANUFACTURING LINES

(71) Applicant: ESPECIALIDADES QUÍMICAS GLOBALES DE MÉXICO, S.A.P.I. DE C.V., CUAUTITLÁN IZCALLI (MX)

(72) Inventors: Felipe MARTÍNEZ NAVA, TLALNEPANTLA DE BAZ (MX); MARIA GUADALUPE HERNANDEZ BALDERAS, CUAUTITLÁN (MX)

(21) Appl. No.: 18/855,538

(22) PCT Filed: Aug. 21, 2023
(86) PCT No.: PCT/MX2023/050051

§ 371 Date: Oct. 9, 2024

(30) Foreign Application Priority Data
Aug. 11, 2022 (MX) MX/A/2022/009900

(51) Int. Cl. C08G 77/34; B01D 3/14; B01D 3/38; B01D 15/10; B01J 20/20; C11D 3/37

(52) U.S. Cl. CPC C08G 77/34; B01D 3/143; B01D 3/38; B01D 15/10; B01J 20/20; C11D 3/373

(57) ABSTRACT

The invention relates to a process for purifying and deodorising silicone used for the washing of cosmetics production lines, in accordance with the invention, consisting in receiving dirty silicone, which is subjected to filtration (a) and, once filtered, to a steam distillation step (b), wherein heating steam (b1) is applied to eliminate lightweight pollutants and water (b2). The raw silicone is subjected to a rectification step (c), wherein the lightweight pollutants with water (c1) and heavy components (c2) are separated to obtain rectified silicone, which is then subjected to a step of adsorption with activated carbon (d), from which spent activated carbon (d1) is derived to finally obtain deodorised silicone (d2).

### FIELD OF THE INVENTION

The present invention is related to industrial processes used to purify substances used in cosmetic manufacturing processes. More specifically, it refers to a silicone purification and deodorization process from washing cosmetic manufacturing lines.

### BACKGROUND OF THE INVENTION

In the cosmetics production industry, a variety of compounds and chemicals are used that are part of the formulation of a variety of cosmetic products and, unfortunately, it is inevitable that they contaminate the production lines when a different batch must be obtained or when the manufacturing of a different cosmetic is required that includes in its formulation other aromas, perfumes, other substances and other compounds, which generates what is known as “cross contamination.”

To solve these problems, silicone is currently used to wash the production lines at each product change Its function is to dissolve the residues of a previous batch of cosmetic and leave the production line clean and free of the perfume “aroma” of the previous cosmetic.

Silicone is not an ingredient per se, it is a compound that is used to wash production lines at each product change. It does not intervene in the formulation of any cosmetic. It is a “cleaning” product. The word residual is used to designate the perfume “odor” or “aroma” content of in silicone after it has been used in a production line cleaning process.

Silicone dissolves the specific “perfume” of each cosmetic that has been processed on the production line. Then, this washing silicone is impregnated with a specific perfume. This silicone can only be reused or recycled in the washing of a production line that has handled the cosmetic that has the same perfume.

The silicone used for these purposes absorbs said perfumes, odors and residual quantities of products used in the formulation of certain cosmetics, so it has to be sent for final disposal, which means confinement or incineration which translates into environmental pollution and production cost, since the washing silicone cannot be recycled, new material must be purchased.

As there is no process that is capable of removing the perfume from the silicone, it cannot be reused in another washing cycle of the production line of a cosmetic with a different perfume, since odor-free silicone is required to make this job.

The inventors do not know any specific process that allows purifying and deodorizing silicone from washing cosmetic manufacturing lines, which is why they developed the present invention that solves the problem described.

A search was carried out to determine the closest state of the art, finding the following documents.

The publication ES2002146 A6 dated Jul. 16, 1988 by Calloni et al. was found, which discloses a procedure for the purification of oils, such as perfluoropolyether oils, silicone oils or oils based on hydrocarbons, contaminated with different impurities and especially by suspended solid matters, materials that can hardly be filtered with conventional filters, comprising a filtration carried out using a tangential circulation type filter, wherein the filter element pores have a diameter less than 0.4 microns.

However, in this case, physical separation methods are used using tangential filters with specific pore diameters, unlike our invention, which uses steam stripping methods, distillation with rectification, deodorization, and filtration in an adsorption column.

Document U.S. Pat. No. 6,312,476 by Robert J. Perry et al. was found dated Nov. 10, 1999, which discloses a process for removing malodorous elements from dry cleaning silicone solvents, which comprises contacting the used silicone solvent with the adsorbent to eliminate the odor and separate the silicone solvent.

The process for removing malodorous elements from a silicone dry cleaning solvent, comprising contacting the silicone solvent with an adsorbent in an amount of about one part by weight of solvent to one part by weight of adsorbent (1:1) to approximately ten parts by weight of solvent to one part by weight of adsorbent (10:1) for an effective period of time (0.1 to about 6 hours) and at temperature of about 10 to about 100° C. to remove malodorous elements, in which the adsorbent is selected from the group consisting of 4A and 13X molecular sieves, and separating the silicone solvent from the adsorbent.

However, in this case only the silicone solvents are brought into contact with an adsorbent; they do not use steam stripping or rectification as in the case of our invention.

Document RU2250278C2 by Dorn Stiven B et al dated Oct. 23, 2020, was found, which reveals a method of removing malodorous elements from silicone solvents; the method consists of contacting the silicone solvent with the adsorbent to eliminate the odor; wherein the solvent is in contact with the adsorbent at temperature of approximately 10-100° C. and wherein the adsorbent is granular activated carbon, 4A or 13X molecular sieves. However, in this case only the silicone solvent is brought into contact with an adsorbent under certain temperature conditions and certain sieve size; they do not use steam stripping or rectification as in the case of our invention.

Document KR100953871B1 by Yoon Dae Sik and Yoon Kang HOON dated Aug. 7, 2008, was found which discloses a method for recovering low molecular weight silicone compounds from silicone waste and, more particularly, by treating silicone waste using mineral oil to recover D3 to D7 low molecular weight silicone compounds, thus increasing the recovery rate and including silicone residues. In this case, mineral oil is used; they do not use steam stripping or rectification as in the case of our invention.

Document WO0134613A1 by Perry Robert James and Riccio Donna A. dated Oct. 26, 2000, was found which discloses a method for stabilizing silicone solvents for dry cleaning containing impurities, which comprises contacting the silicone solvent with an adsorbent, neutralizing agent, or a combination thereof to purify the solvent and prevent rebalance and polymerization and separate the silicone solvent. However, like some of the aforementioned documents, they do not use steam stripping or rectification as in the case of our invention.

No document was found that discloses a process like our invention, and other processes may exist with many combinations of different process steps; that is, the different recuperators will have “invented” or “proposed” their own technique; but no silicone purification and deodorization process from washing cosmetic manufacturing lines was found, like our invention that solves the problem in a practical, simple and functional way.

### OBJECTS OF THE INVENTION

The main object of the present invention is to provide a process for purifying and deodorizing silicone from washing cosmetic manufacturing lines with steam stripping, followed by a distillation with rectification at reduced pressure and an adsorption process using activated carbon. Another object of the invention is to provide said silicone purification and deodorization process from washing cosmetic manufacturing lines, which also eliminates environmental contamination by silicone used in washing cosmetic production lines and that allows production costs to be significantly reduced by being able to reuse silicone.

Another object of the invention is to provide said process for purifying and deodorizing silicone from washing cosmetic manufacturing lines, which also allows the silicone used in washing cosmetic production lines to be recycled indefinitely, without the need to replace it with virgin silicone.

Another object of the invention is to provide said process for purifying and deodorizing silicone from washing cosmetic manufacturing lines, which also allows the purified silicone to be used for cleaning production lines where different cosmetic products are manufactured.

Another object of the invention is to provide said process for purifying and deodorizing silicone from washing cosmetic manufacturing lines, which is also practical, simple, and functional.

And all those qualities and objects that will become apparent when making a general and detailed description of the present invention supported by the illustrated modalities.

### BRIEF DESCRIPTION OF THE INVENTION

The invention focuses on a separation process, where unitary operations are used to not affect the chemical structure or physical properties of the silicone.

In order to define the process, the “dirty” silicone process had to be characterized first to know its contaminants, these contaminants were classified as “light fractions” such as Cyclotetrasiloxane Octamethyl and Ethanol, “heavy fractions such as Methyl Ethyl Carbinol, .-Linalool, Benzyl Ethanoate, Phenyl Ethyl Alcohol, 2,6-Di-tert-butyl-1,4-benzoquinone, 4-Methyl-1,3-Dioxolan-2-One and smell” as Terpene: .-Linalool, based on this, unitary separation operations could be established to eliminate each of the contaminants.

To eliminate light contaminants, a steam stripping elimination step was devised; to eliminate odors, a deodorization step was devised and to eliminate heavy contaminants, a rectification step was devised.

The tests were carried out varying the steps order and it was surprisingly found that the optimal order to achieve an adequate separation is to first start with a steam stripping step for the elimination of light contaminants, followed by a rectification step for the elimination of heavy contaminants to finally subject the silicone to a deodorization step with activated carbon where the odor is completely eliminated.

The results obtained in the first two steps were satisfactory, with the third deodorization step being the most complicated, as it is the one that must produce a practically pure silicone. Here deodorization techniques with activated carbon were tested, using various activated carbon types, carrying out the process continuously and also in batches and varying the process temperatures. Obtaining the deodorized silicone in the laboratory, a procedure was developed indicating the process parameters and scaling said process to an industrial plant, replicating the results obtained in laboratory and verifying the technology on an industrial scale.

To better understand the characteristics of the invention, the present description is accompanied, as an integral part thereof, by the drawings with an illustrative but non-limiting nature, which are described below.

### BRIEF DESCRIPTION OF THE FIGURES

FIG. 1 shows a block diagram of the silicone purification and deodorization process from washing cosmetic manufacturing lines, in accordance with the present invention.

FIG. 2 shows a flow diagram of the steam stripping step to remove light contaminants from the silicone purification and deodorization process from washing cosmetic manufacturing lines, in accordance with the present invention.

FIG. 3 shows a flow diagram of the rectification steps to eliminate heavy contaminants and the deodorization step to eliminate silicone odor, of the silicone purification and deodorization process from washing cosmetic manufacturing lines, accordance with the present invention.

For a better understanding of the invention, a detailed description of some of its modalities will be made, shown in the drawings that are attached to this description for illustrative but not limiting purposes.

### DETAILED DESCRIPTION OF THE INVENTION

The characteristic details of the silicone purification and deodorization process from washing cosmetic manufacturing lines are clearly shown in the following description and in the attached illustrative drawings, the same reference signs serving to indicate the same parts.

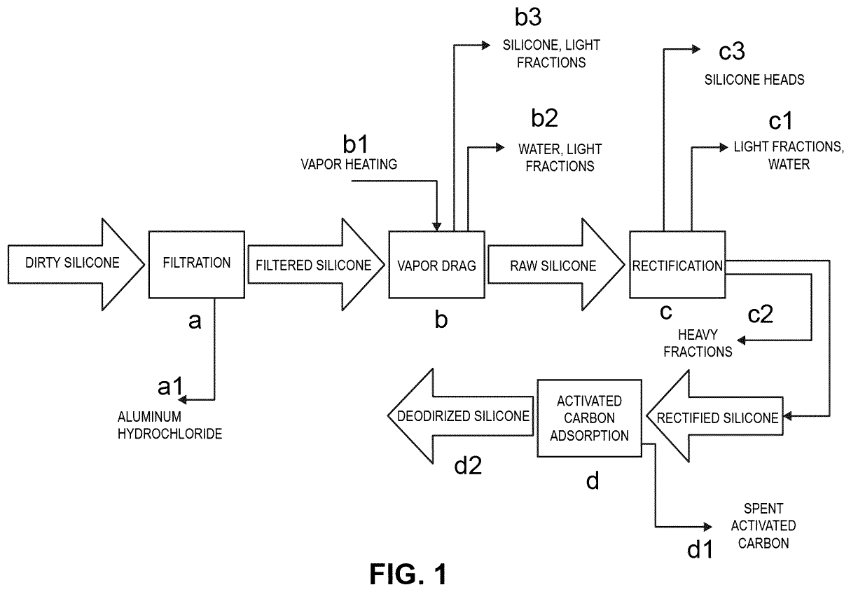

According to FIG. 1, the silicone purification and deodorization process from washing cosmetic manufacturing lines, in accordance with the present invention consists of receiving the dirty silicone that is subjected to filtration (a) to eliminate aluminum hydrochloride (al) and once filtered, pass it through a steam stripping step (b) where live heating steam (b1) is applied to eliminate light contaminants and water (b2) and also obtaining a silicone fraction with light contaminants (b3); the raw silicone is taken to a rectification step (c) where light contaminants are separated with water (c1), silicone heads (c3) and heavy components (c2) to obtain rectified silicone which is taken to an activated carbon adsorption step (d) from which spent activated carbon (d1) is derived to finally obtain deodorized silicone (d2).

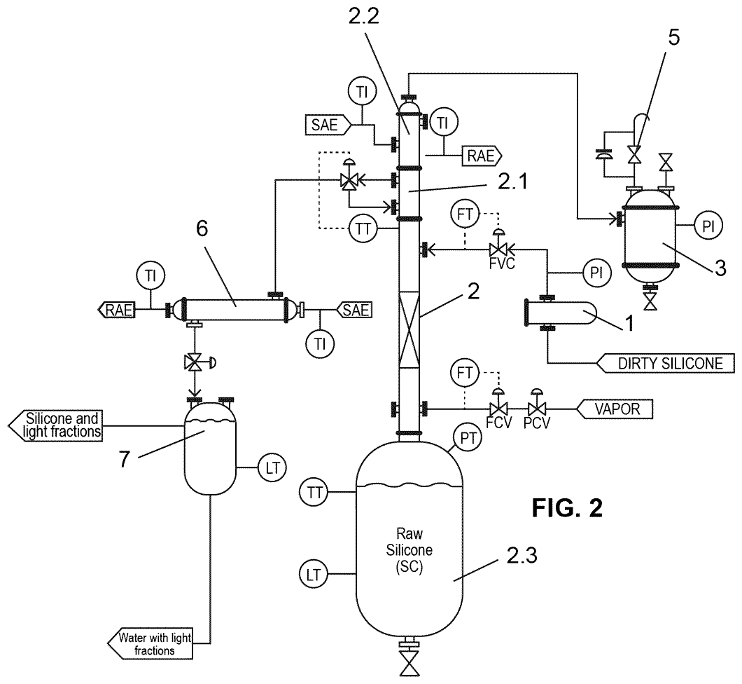

In accordance with FIG. 2, dirty silicone is received at temperature between 20° C. to 25° C. and is passed through a filter (1) and is taken through a duct where a pressure indicator (PI) is provided followed by a flow control valve (FVC), defining a controlled flow transmission (FT) where silicone is fed at temperature between 50° C. to 60° C. which can be preheated in an economizer (not shown) in the upper section of a packed depletion column (2) for a steam stripping carried out at atmospheric pressure; where at the base of the packed depletion column (2) live heating “steam” is applied through a duct with a flow control valve (FCV) and pressure control valve (PCV) defining a controlled flow transmission (FT). At the top of the tower a reflux head (2.1) is installed and above is a tubes and shell condenser (2.2) connected by pipe to an atmospheric vent tank (3) with a pressure indicator (PI), whose vent valve (5) must remain open during distillation. The condenser (2.2) is supplied with cooling water (SAE) with a temperature indicator (TI) and with a cooling water return (RAE) with a temperature indicator (TI). The light contaminants and water leave the reflux head and are taken to a tube and shell cooler (6) that receives the condensed components (heads) and cools them, sending them to the separator tank (7) that has a level transmitter, obtaining a heavy fraction of water with light fractions and a light fraction of silicone and ethanol.

Said tube and shell cooler (6) is supplied with cooling water (SAE) with a temperature indicator (TI) and with a cooling water return (RAE) with a temperature indicator (TI). The live steam fed from the base of the packed depletion column (2) is fed at a gauge pressure of between 1.0-1.4 Kg/cm² (98.0665 to 137.293 Kpa), preferably at a pressure of 1.2 Kg/cm² (117.68 Kpa). Wherein the flow ratio is between 6-8 to 1 and preferably 7 to 1, that is, 7 parts of silicone to one part of live steam.

The distillation temperature in the dome of the packed depletion column (2) is between 85° C. to 100° C. and preferably 92° C. Silicone descends from the dome of the packed depletion column (2) and steam rises from the base of the packed depletion column (2). Within the packed depletion column (2), both streams are brought into contact through the stainless-steel packaging. Mass and heat transfer is carried out, rising water steam with the distillated light fractions, leaving the heads through the dome, and reaching the tubes and shell condenser (2.2), where the heads are condensed. Phase separation is carried out in the receiving tank (7), sending the water with light fractions such as ethanol to final disposal and some amount of distilled silicone to storage for reprocessing in another depletion operation. Through the lower area of the column, the raw silicone is obtained and stored in the distillation pot (2.3) which has a level transmitter (LT), a temperature transmitter (TT) and a pressure transmitter (PT).

The silicone, free of light components that give it a large part of its odor, is obtained at temperature between 70° C. and 80° C.; and is kept inside the distillation pot until the next step of the process begins. The yield of this operation is 95%.

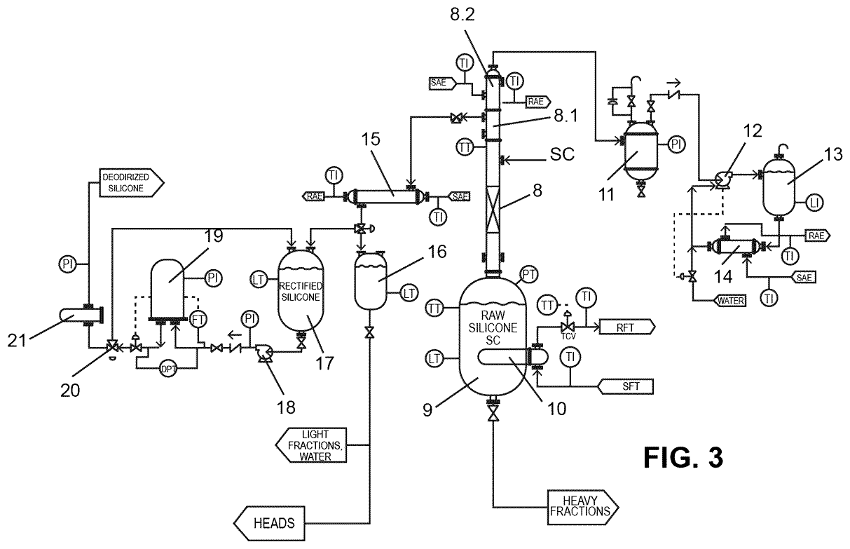

According to FIG. 3, the next step of the process consists of rectification, which is a batch process (BATCH) at reduced pressure, carried out in a rectification column (8), coupled to the distillation pot (9) that receives the raw silicone (SC) from the steam stripping step, and wherein said distillation pot (9) is a vertical cylindrical container, with a “bayonet” type heat-exchanger (10). The distillation pot (9) comprises a heating medium using thermal fluid (SFT) at 200° C. with a temperature indicator (TI), which raises the temperature of the raw silicone to temperature between 150 to 190° C. and preferably to 170° C., comprising temperature control valve (TCV) with temperature transmitter (TT) and thermal fluid outlet temperature indicator (TI) (RFT); and wherein said distillation pot (9) comprises a level transmitter (LT), a temperature transmitter (TT) and a pressure transmitter (PT). Through the dome top, first exit the light fraction with water and then the heads at temperature between 85° C. to 100° C. and preferably 92° C., which is taken to a tubes and shell condenser (8.2) that receives the evaporated components (heads) and condenses them, sending them to the reflux head (8.1) that has a temperature transmitter (TT) and from there to the condensate cooler (15) and discharging the condensates to a receiving tank (16). The reflux head sends part of the condensate to the rectification column dome (8) as rectifying reflux; said condenser (8.2) is connected to a vacuum lung (11) that has a pressure indicator (PI) and from there connected to a liquid ring vacuum pump (12) that recirculates water to a recirculation tank (13) featuring a level indicator (LI), with liquid cooler (14) to which cooling water is supplied (SAE) with a temperature indicator (TI) and with a cooling water return (RAE) with temperature indicator (TI). Vacuum is gradually applied to reduce the system pressure between 340 to 360 mm Hg (45.3296 Kpa to 47.9961 Kpa), preferably 350 absolute mm Hg (46.6628 Kpa).

During the operation to reach the distillation temperature of the silicone, the first fraction or distillation “heads” begins to evaporate, composed of water, light fractions and silicone. In turn, the condensation of this fraction begins. This is done to ensure that only water and light fractions are distilled. The reflux ratio at this step is 4:1, that is, for 5 distilled parts, 4 are returned as rectifying reflux and one is obtained as distillate. The rectifying reflux is only silicone, and the distillate is water, light fractions, and a small amount of silicone. This amount of distillate represents 10% to 15% of the initial charge to the distillation pot (9).

Once the first fraction has been distilled and reaching a temperature at the column top of 150° C. (maximum) 160° and absolute pressure of 350 mm Hg (46.6628 Kpa), the distillation of the silicone begins. This operation is carried out with rectifying reflux in a ratio of 4:1 to ensure that only silicone distills, separating the heavy components of the charge, which are kept in the distillation pot (9). When the temperature of the column dome begins to increase beyond 160° C., it means that all the silicone has been distilled and the heavy components remain in the distillation pot (9), which will be sent to final disposal. This amount is 10% of the initial charge.

In the upper area of said rectification column (8), cooling water (SAE) with a temperature indicator (TI) and a cooling water return (RAE) with a temperature indicator (TI) is supplied.

The rectified and anhydrified silicone that comes out of the rectification column (8) passes through a distillate cooler (15), where its temperature drops between 50°−60° C., cooling water (SAE) is supplied to said distillate cooler (15) with a temperature indicator (TI) and with a cooling water return (RAE) with a temperature indicator (TI). The yield of this operation is 75%. From the distillate cooler (15), heads are derived towards a head receiving tank (16) that comprises a level transmitter (LT) and rectified silicone that is discharged to a rectified silicone receiving tank (17) that comprises a level transmitter (LT) and which is pumped by a pump (18) with a pressure indicator (PI) to the silicone deodorization step that is carried out in an activated carbon filter (19) that comprises a flow transmitter (FT), a pressure indicator (PI) and a differential pressure transmitter (DPT), is a continuous process at atmospheric pressure, carried out in equipment that contains a activated carbon bed, whether granular or in cartridge; at the outlet of said activated carbon filter (19) there is a flow control and recirculation valve (20) that allows a flow to be recirculated to said rectified silicone receiving tank (17) and the conduction of silicone to the polishing filter (21) followed by a pressure indicator (PI) to finally obtain deodorized silicone.

The rectified and anhydrified silicone at temperature of 50°−60° C. is pumped through the activated carbon bed to eliminate the last traces of odor. The pumping pressure is 1.0 Kg/cm² (98.0665 Kpa). The operation is carried out first by recirculating to the rectified silicone receiving tank (17) and samples of the product are taken after passing through the activated carbon bed, to verify that the product is odor-free. This verification is carried out in the laboratory, where other parameters are also measured, such as color, humidity, density, and purity. If the silicone is already odor-free, recirculation to the feed tank (17) is stopped and it is passed through the polishing filter (20) and the deodorized silicone is sent to a finished product storage tank (not shown). The yield of this operation is 90%. The spent activated carbon is sent for final disposal.

On average, the total yield of the entire process is between 60%-65%.

The invention has been described sufficiently so that a person with average knowledge in the field can reproduce and obtain the results that we mention in the present invention. However, any person skilled in the field of art that is the subject of the present invention may be able to make modifications not described in the present application, however, if for the application of these modifications in a given structure or in the manufacturing process of the same, the material claimed in the following claims is required, said structures must be included within the scope of the invention.

Having sufficiently described the invention, what is contained in the following vindication clauses is claimed as property:

1. A silicone purification and deodorization process from washing cosmetic manufacturing lines, characterized in that it comprising a steam stripping step to eliminate light contaminants where the dirty silicone is received at previously filtered room temperature and preheated to temperature of between 50° C. to 60° C. in a packed depletion column; feeding steam through the base of the column at a pressure of between 98.0665 to 137.293 Kpa with a flow ratio between 6-8 parts of silicone to 1 part of steam and at a distillation temperature between 85° C. to 100° C.; extracting heads through the dome of the column that are water plus light fractions; condense the heads in a condenser separating water with light fractions such as ethanol that are sent to final disposal and a quantity of distilled silicone to storage to be reprocessed in another depletion operation; receiving silicone free of light components at the base of the column at temperature between 70° C. to 80° C. in a distillation pot; a rectification step for the elimination of heavy contaminants in a rectification column, coupled to said distillation pot where the temperature is raised to between 150 to 190° C. prior to entering the rectification column, with the heads emerging through the dome at temperature between 85° C. to 100° C. towards a condenser for phase separation of water plus heavy fractions for final disposal and separating the rectified silicone, wherein a fraction of silicone rectifier reflux is returned to said rectification column and another flow is sent to deodorization step with activated carbon; the process also includes a vacuum system that gradually applies vacuum to reduce the system pressure from between 45.3296 Kpa to 47.9961 Kpa.

2. The silicone purification and deodorization process from washing cosmetic manufacturing lines, according to claim 1, characterized in that in said steam stripping step for removal of light contaminants the flow ratio is 6-8 parts silicone to 1 part steam.

3. The silicone purification and deodorization process from washing cosmetic manufacturing lines, according to claim 1, characterized in that in said steam stripping step for removal of light contaminants the yield is 95%.

4. The silicone purification and deodorization process from washing cosmetic manufacturing lines, according to claim 1, characterized in that said rectification step for the elimination of heavy contaminants is in batches under reduced pressure.

5. The silicone purification and deodorization process from washing cosmetic manufacturing lines, according to claim 1, characterized in that the heating of the raw silicone in the distillation pot is through a thermal fluid at 200° C.

6. The silicone purification and deodorization process from washing cosmetic manufacturing lines, according to claim 1, characterized in that said rectification step for the removal step of heavy contaminants has a yield of 75%.

7. The silicone purification and deodorization process from washing cosmetic manufacturing lines, according to claim 1, characterized in that in said rectification step for elimination of heavy contaminants, the reflux ratio is 4:1, that is, for 5 parts distilled, 4 are returned as rectifying reflux and one is obtained as distillate.

8. The silicone purification and deodorization process from washing cosmetic manufacturing lines, according to claim 1, characterized in that the silicone deodorization step is carried out with activated carbon continuously at atmospheric pressure by recirculation pumping at a pumping pressure of 98.0665 Kpa, carried out in equipment that contains an activated carbon bed, whether granular or in cartridge, a recirculation pump and polishing filter.

9. The silicone purification and deodorization process from washing cosmetic manufacturing lines, according to claim 1, characterized in that the average yield of the complete process is between 60%-65%.
